(19) United States
(12) Patent Application Publication
(10) Pub. No.: US 2006/0058101 A1
(43) Pub. Date: Mar. 16, 2006

(54) CREATING AND SELLING A MUSIC-BASED VIDEO GAME

(75) Inventor: Alexander P. RIGOPULOS, Watertown, MA (US)

Correspondence Address: LAHIVE & COCKFIELD, LLP., 28 STATE STREET, BOSTON, MA, 02109, US

(73) Assignee: HARMONIX MUSIC SYSTEMS, INC., Cambridge, MA (US)

(21) Appl. No.: 10/711,398

(22) Filed: Sep. 16, 2004

(51) Int. Cl. A63F 13/00

(52) U.S. Cl. 463/35

(57) ABSTRACT

A method for creating and selling a music-based video game includes selecting music content. A video game is created that is based on the selected music content. The created video game is offered for sale in a manner typically associated with a recorded music product.

### FIELD OF THE INVENTION

The present invention relates generally to entertainment products and, more particularly, to techniques and methods for creating and selling video games based on music typically available to consumers as recorded music products such as compact discs (CDs), digital versatile discs (DVDs), cassette tapes, vinyl albums, or computer files.

### BACKGROUND OF THE INVENTION

Music-based video games are video games that rely on music for a dominant gameplay characteristic. These games have, in many cases, received a high degree of critical acclaim. However, even highly acclaimed music-based video games have not, to date, been as commercially successful as video games from other genres, nor have they been as commercially successful as recorded music products, such as compact discs and albums issued by popular musical artists.

At least one barrier to wider consumption of music-based video games has been the way in which those products are created, marketed, and distributed. Historically, music-based videogames have been created, marketed, and distributed alongside other genres of video game, such as sports games, fighting games, or role-playing games. Music-based video games are unusual in that, due to the strong emphasis on music in the game, a player's enjoyment of a music-based video game is directly related to the player's enjoyment of the specific music on which the video game is based. Consumer tastes in music vary widely, so a song or artist that is enjoyed by one consumer might be unappealing to a majority of other consumers. Consequently, music-based video games are subject to consumers' highly fragmented taste in music. Historically, music-based video games generally have not been created based upon the music of a specific popular recording artist, but rather on a broad collection of music from a wide variety of artists for a “general audience” of video game consumers. This approach attempts to provide “something for everyone”, but in practice, the lack of focus fails to provide a critical mass of musical content that will be strongly appealing to any one individual's taste. Furthermore, unlike distribution channels for recorded music, video game distribution channels provide no efficient means for placing a music-based video game at retail in such a manner as to target fans of a specific artist upon which the game has been based. Historically, the video game industry's manner of creating, marketing, and distributing music-based video games has been in direct conflict with the unique requirements of effective creation and selling of music-based games.

The present invention addresses these issues.

### BRIEF SUMMARY OF THE INVENTION

The present invention provides new ways to create and sell music-based video games. Although the created music-based video game may be sold through traditional game channels, it is contemplated that the created music-based video game may also be sold through channels and in manners more traditionally associated with recorded music products. Selling the created music-based video games in this manner allows them to be made available to consumers with a particular affinity for music generally, or an affinity specifically for the music or the musical artist on which the video game is based, in the normal course of those consumers' buying behavior for recorded music products. In some instances, the video game may be co-located with a recorded music product on which it is based. Alternatively, the music-based video game may benefit from co-marketing efforts directed to consumers of the associated recorded music product.

In one aspect the present invention relates to a method for selling a video game based on a recorded music product. A quantum of recorded music content is selected and a video game based on the selected music content is created. The created video game is then offered for sale in a manner typically associated with the recorded music content on which the video game is based.

In another aspect, the present invention relates to a method for creating an interactive music video. A computer-generated rendition of a musical artist is created. A game is created that is based on a musical composition and which includes the computer-generated rendition of the musical artist as a game element.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a flowchart depicting one embodiment of the steps taken to create and sell a music-based video game product;

FIG. 1B is a block diagram depicting a gaming platform suitable for use with some embodiments of the present invention;

FIG. 2 is a diagrammatic view of an embodiment of a rhythm-action video game;

FIG. 3 is a diagrammatic view of another embodiment of a rhythm-action video game;

FIG. 4 is a is a diagrammatic view of an embodiment of a singing video game;

FIG. 5 is a diagrammatic view of an embodiment of a dancing video game; and

FIG. 6 is a diagrammatic view of an embodiment of a music-based third-person character-action video game.

### DETAILED DESCRIPTION OF THE INVENTION

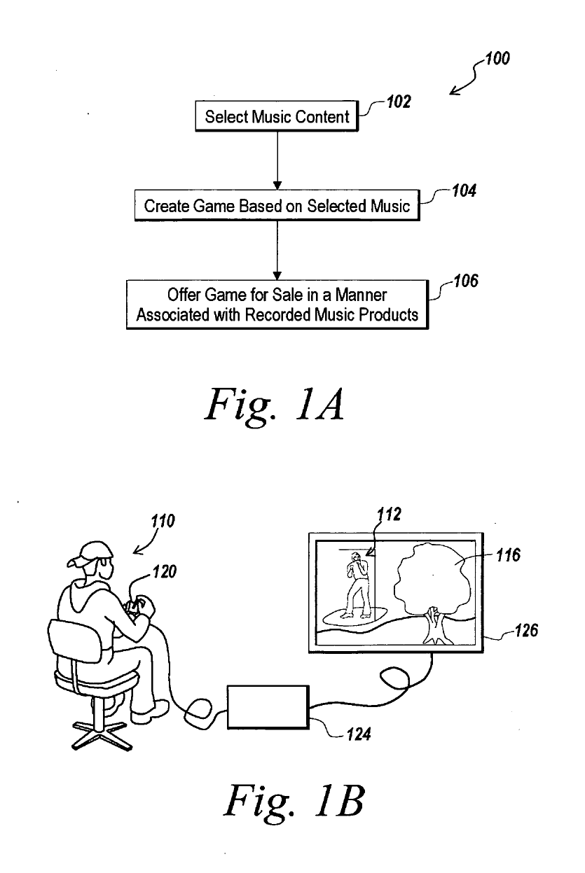

Referring now to FIG. 1A, one embodiment of the steps to be taken in a method 100 for selling a music-based video game is shown. As used in this specification, the term “music-based” video game refers to a game in which one or more of the dominant gameplay mechanics of the game are based on player interaction with the musical soundtrack. One example of a music-based video game is Karaoke Revolution, sold by Konami Digital Entertainment; in this game, one of the dominant gameplay mechanics is reproducing, by a player's voice, the pitch and timing of notes from popular songs. Another example of a music-based video game is BeatMania, also sold by Konami; in this game players attempt to strike controller buttons in time to a musical composition. These and other examples are are discussed below. Also, certain video games have historically utilized the likenesses of popular recording artists and/or music from popular recording artists for the games' soundtracks, but the gameplay itself was not based on player interaction with the soundtrack. One example of such a game is Def Jam Vendetta, sold by Electronic Arts. This is a wrestling game featuring popular hip hop artists as wrestlers and music from those artists on the soundtrack. The gameplay itself is simply wrestling, however, and thus is not music-based.

The embodiment of a method for creating and selling a music-based video game is shown in FIG. 1A includes the steps of: selecting music content (step 102); creating a video game based on the selected music content (step 104); and offering for sale the created music-based video game in a manner typically associated with a recorded music product that includes the music content on which the video game is based (step 106).

Still referring to FIG. 1A, and in greater detail, music content is selected (step 102). The selected music content may represent a complete recorded music product, such as an entire album, or it may represent only a portion of a recorded music product, such as a single song, or a portion of a single song, included on a recorded music product. It may also represent a collection of songs from multiple recorded music products, such as “greatest hits” of a particular recording artist or by a group of artists. In still other embodiments, the selected music content may not exist as a part of a separately available recorded music product. In some cases, the selected music content may not be a recording per se, but rather a composition that the game creator will have re-recorded.

One criterion that may be used to select musical content is whether the music is suitable for the intended music-based video game. For example, if the intended video game is a rhythm-based game, only songs, or tracks from songs, having a prominent rhythmic component may be selected. Similarly, if the intended video game is a singing game, only songs having a particularly “singable” melody may be selected. Another selection criterion that may be used is whether consumers who enjoy recorded music products from a particular artist also enjoy playing video games, thereby making those consumers a suitable audience for a video game based on the music of the artist. Yet another selection criterion that may be used is the popularity of the recording artist responsible for creating or making popular the music content, which is partly indicative of the potential market size for a video game created based upon the selected music content.

Before creating or selling a video game based on the selected musical content, the game creator, or some party selling the video game on behalf of the game creator, obtains the appropriate license or licenses to use the selected musical content in the video game. Such licenses might include “synchronization” licenses on the selected compositions, or lyrics rights, obtained from the song publishers. Alternatively, when original master recordings are used, appropriate masters/recording licenses are secured from the appropriate record companies. In other embodiments, a license to reproduce an artist's likeness may be necessary. Licensed content, whether from a recorded music product or not, will be referred to throughout this description as “licensed music content”. The term “licensed” is also understood to apply here to scenarios in which a single party owns all rights associated with the music content and the created game, in which case an actual license is not needed.

Based in part on the type of license secured, the licensed musical content may be delivered to the entity creating the music-based video game. One or more “tracks” from the “master” of a recorded music product may be delivered. As is well-known in the music recording art, a musical recording made in a studio typically comprises several “tracks;” often, each track represents a different musical “voice,” e.g. drums, guitar, vocals, effects, etc. In some embodiments, a subset of the tracks comprising the entire recorded music product is received. In other embodiments, all of the tracks for a subset of the recorded music product are received. For example, an album of popular music may comprise several individual songs, of which only predetermined ones are received. In still other embodiments, a subset of the tracks for a subset of the recorded music product is received. In still other embodiments, all of the individual tracks for the entire recorded music product are received. In still other embodiments, a stereo master is received.

In other embodiments, the game creator may not receive tracks representing the recorded music product from which the music content is selected. In these embodiments, the game creator may record, produce, or have recorded or produced on its behalf, its own version of the licensed music content for inclusion in the video game.

The musical content may be received either in analog or digital format and may be received via a computer network. For embodiments in which the musical content is received in analog format, it may be embodied on suitable magnetic media, such as reel-to-reel tape. For embodiments in which the music content is received in digital format, the music content may be embodied on a digital data carrier, such as a hard drive, compact disc (CD), digital versatile disc (DVD), flash memory, or digital music tape (DAT). The musical content may be received in a number of different digital formats such as mp3, aiff, wav, or wmv. In still other embodiments, the musical content may be received as ProTools session data, which comprises parallel streams of digital music data. In still other embodiments, the musical content may be received in MIDI format.

The musical content may be received via a network, such as a local area network (LAN), a metropolitan area network (MAN), or a wide area network (WAN) such as the Internet using a variety of connections including standard telephone lines, LAN or WAN links (e.g., T1, T3, 56 kb, X.25), broadband connections (ISDN, Frame Relay, ATM), and wireless connections (GSM, CDMA, W-CDMA). A variety of data-link layer communication protocols may be employed (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections). Further, in these embodiments the received musical content may be encrypted using any one of a number of well-known encryption protocols, e.g., DES, triple DES, AES, RC4 or RC5.

Still referring FIG. 1A, a video game product is created that is based on the selected musical content (step 104). The video game may be created for any of a number of gaming platforms. The gaming platform may be a personal computer, such as any one of a number of machines manufactured by Dell Corporation of Round Rock, Tex., the Hewlett-Packard Corporation of Palo Alto, Calif., or Apple Computer of Cupertino, Calif. Although games manufactured to be played on personal computers are often referred to as “computer games” or “PC games,” the term “video game” is used throughout this description to refer to games manufactured to be played on any platform, including personal computers.

In other embodiments the game platform is a console gaming platform, such as GameCube, manufactured by Nintendo Corp. of Japan, PlayStation 2, manufactured by Sony Corporation of Japan, or Xbox, manufactured by Microsoft Corporation of Redmond, Wash. In still other embodiments, the game platform is a portable device, such as GameBoy Advance, manufactured by Nintendo, the PSP, manufactured by Sony or the N-Gage, manufactured by Nokia Corporation of Finland.

As shown in FIG. 1B, the game platform 124 may be in electrical communication with a display device 126. Although shown separate from the game platform in FIG. 1B, the display device 126 may be affixed to, or a unitary part of, the game platform 124. For example, the N-Gage and GameBoy Advance units have built-in display screens 126. The game platform 124 produces display data representing a game environment. As shown in FIG. 1B, the game platform 124 displays a game environment that includes a game character 112 and a game element 116 with which the player 110 can make the character 112 interact using input device 120. The input device 120 may be a traditional game controller associated with game platforms like the Sony PlayStation, Sony PlayStation 2, the Microsoft Xbox, and Nintendo GameCube. In other embodiments, the input device 120 is a joystick, a steering wheel, a microphone, a dance pad, a drum pad or other musical controller, or a camera. In still other embodiments, multiple input devices 120 are used to interact with the game. Although shown separate from the game platform in FIG. 1B, the input device 120 may be affixed to, or a unitary part of, the game platform 124.

As noted above, a video game is created based on the licensed music content (step 104). For embodiments in which the licensed music data comprises several different tracks, gameplay actions may be associated with at least some of the tracks, as will be described in more detail in connection with the examples below, which are intended to be exemplary of the types of music-based video games that may be created and sold in the manner described above and are no way intended to limit the scope of the invention.

### EXAMPLE 1

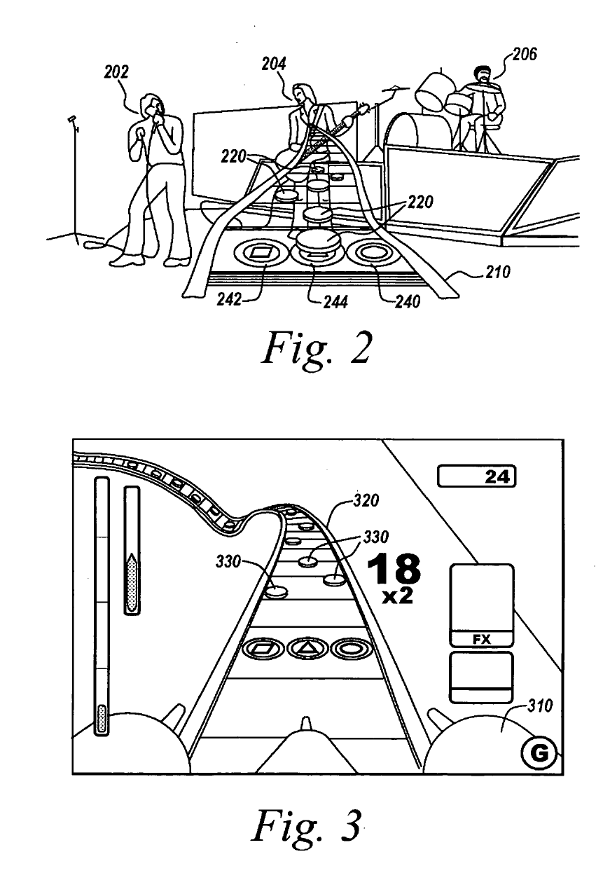

Referring now to FIG. 2, the video game may be based on all, or a portion of, licensed music content created by a popular band enjoyed by specific consumers. As can be seen from FIG. 2, each of the members of the band 202, 204, 206 has been modeled and animated in the game environment. The game includes a “lane” 210 that appears to be three-dimensional, that is, it appears to lie in a plane between the player of the game and one of the animated band members. The player is able to choose a particular animated member of the band to interact with using a game controller. The image of the band member may be computer-generated or, alternatively, a digital image, such as a video capture, of the band member may be used.

It is, of course, understood that the display of three-dimensional “virtual” space is an illusion achieved by mathematically “rendering” two-dimensional images from objects in a three-dimensional “virtual space” using a “virtual camera,” just as a physical camera optically renders a two-dimensional view of real three-dimensional objects. Animation may be achieved by displaying a series of two-dimensional views in rapid succession, similar to motion picture films that display multiple still photographs per second.

FIG. 2 depicts an embodiment of a rhythm-action video game in which a lane 210 has one or more game “cues” or elements corresponding to musical data 220 that appear to flow from the depicted band member 204 to the user, synchronized to the music the depicted band member 204 (and, by extension, the game player) is, or should be, currently playing. In the example shown in FIG. 2, the player is interacting with a lane 210 extending from the guitar player 204, the game elements 220 may represent various pieces of data about the guitar notes that the band member 204 is playing in the song, such as timing, pitch, volume, duration, articulation, timbre or any other time-varying aspects of the guitar player's part. The lane 210 thereby is a representation of the musical time axis. Player interaction with the game element 220 may be required in a number of different ways. In one embodiment, the player may have to “shoot” the game elements by pressing a game controller button synchronized with the passage of the game element under a target marker 240, 242, 244, much like the gameplay mechanics in two rhythm-action games published by Sony Computer Entertainment America for the PlayStation 2 console: FreQuency and Amplitude. In another embodiment, the player operates a “scoop” that slides back and forth along the lane (or other visual display of the musical time axis). The player must keep the scoop aligned with the game elements as they flow to or from the musician 204, much like one of the gameplay mechanics featured in a rhythm-action game published by Koei, Gitaroo-man.

Although shown in FIG. 2 as a small orb, or gem, the game elements 220 may be any geometric shape, and may have transparency, color, or variable brightness to indicate some aspect of the music. For example, game elements 220 may glow more brightly when a band member plays an instrument more loudly. As the game elements move along the lane, the musical data represented by associated graphical symbols may be substantially simultaneously played as audible music. In some embodiments, audible music is only played if the player successfully shoots or scoops the game elements. In these embodiments, successfully shooting or scooping the game elements triggers or controls the animations of the band members.

As shown in FIG. 2, the lane 210 does not always extend perpendicularly from the image plane of the display. In further embodiments, the lane 210 may be curved or may be some combination of curved portions and straight portions. In still further embodiments, the lane 210 may form a closed loop through which the game elements 220 travel, such as a circular or ellipsoid loop. In some embodiments, the time axis lies in the plane of the display. In still other embodiments, the surface of the lane may be subdivided along the time axis into a plurality of segments. Each segment may correspond to some unit of musical time, such as a beat, a plurality of beats, a measure, or a plurality of measures. The segments may be equally-sized segments, or each segment may have a different length depending on the particular musical data to be displayed. In addition to musical data, each segment may be textured or colored to enhance the interactivity of the display.

The embodiment of a rhythm-action game depicted in FIG. 2 can be used to create an interactive music video in which the game player “controls” one or more computer-generated or digitized images of musicians using a game controller. In certain embodiments the controlled musician or musicians are the musical artists responsible for making a song popular. In other embodiments, the depicted musician is the artist who created the song. In still other embodiments, the depicted musician may have no previous affiliation with the performed song. For example, a game player may enjoy using the digitized image of a particular, popular guitar player and the game player may use that image for all songs. In these embodiments, successful shooting or scooping of game elements on a lane extending to the digitized image of the musical artist causes the computer generated musical artist to play an instrument. For example, successfully shooting or scooping game elements on a lane extending to a drummer may cause the drummer to strike the drums in synchrony with the successfully shot or captured game elements. In some of these embodiments, capturing a number of successive game elements, or notes, may cause the corresponding animated band member to execute a “flourish,” such as a “windmill” on a guitar or throwing drum sticks. In specific ones of these embodiments, the flourish that is executed is consistent with real-world physical actions of the computer generated band members. In some embodiments, the player is not visually controlling a computer generated on-screen musician at all; the images of the musicians are digitized video captured, and the player's interaction is only with the musical soundtrack.

In some embodiments, the player can use an input device to transition between band members 202, 204, 206 in order to perform different parts of a song or, alternatively, the game may control which musician the game player must control at various points in the video. In further embodiments, multiple players may play simultaneously, either locally or via a network, allowing them to combine to recreate an entire song at once. In these embodiments, players may recreate musical compositions by successfully performing tracks associated with various instruments originally used to record the music. For example, a player may perform a drum track, use the controller to transition to the guitar track, and perform the guitar track while the drum track continues to play.

### EXAMPLE 2

Referring now to FIG. 3, another embodiment of a rhythm-action video game is shown in which a lane that appears to be three-dimensional represents a particular instrument or voice present in a song. As will be familiar to those having experience with two games sold by Sony Computer Entertainment America, FreQuency and Amplitude, the player controls a “beat blaster” 310 to travel along lanes 320 and shoot in synchrony with the music game elements 330 displayed on the lane 320. Successfully shooting game elements 330 causes the music associated with the game element 330 to be played. Except for the absence of the digitized images of band members responding to game activity, gameplay mechanics are the same as those described above in Example 1. Other examples of rhythm-action games include Parappa the Rapper, Beat Planet Music, Stolen Song, and EyeToy: Groove, all of which are sold by Sony Computer Entertainment; BeatMania, DrumMania, KeyboardMania, and Guitar Freaks, all of which are sold by Konami Digital Entertainment; Taiko no Tatsujin, sold by Namco; Donkey Konga, sold by Nintendo; Quest for Fame, sold by International Business Machines; Mad Maestro, sold by Eidos; Space Channel 5, sold by Sega; and Gitaroo-man, sold by Koei.

### EXAMPLE 3

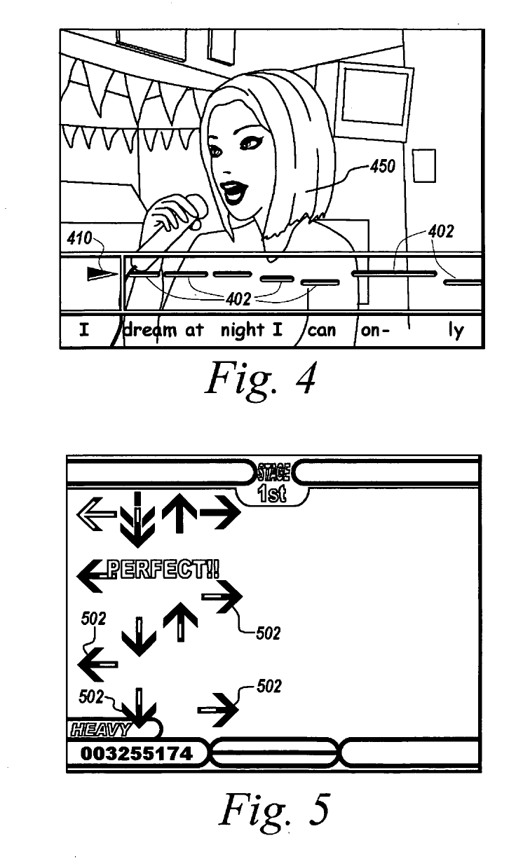

Referring now to FIG. 4, an embodiment of a “sing-along” video game is shown. The notes of a vocal track are represented by “note tubes” 402 that appear along the bottom of the gameplay screen and flow horizontally as the music plays. The vertical position of the note tube represents the pitch to be sung by the player; the length of the note tube indicates for how long the player must hold that pitch. The triangle 410 provides the player with visual feedback regarding the pitch of the note that is currently being sung.

In this example, a player is allowed to “sing-along” with content from licensed songs that have been used to form the basis for the video game. In some embodiments, the game allows a player to “sing-along” with the musical artist responsible for the licensed songs. In these embodiments, the player's character 450 may have the appearance of the musical artist with whom the song in most strongly associated.

In embodiments in which the gaming platform is provided with a camera, the camera may be used to capture movements of the player, allowing the player to “karaoke” more than just the vocal track. For example, the camera may capture the position and movements of the player's hands, allowing the player to attempt to play along with the drum track for a musical composition.

Other examples of “sing-along” video games include Karaoke Revolution, sold by Konami Digital Entertainment; SingStar by Sony Computer Entertainment and Get On Da Mic by Eidos.

### EXAMPLE 4

Referring now to FIG. 5, an embodiment of a “dance-along” video game is shown, in which a player is required to execute specific dance moves in synchrony with music. “Dance-along” games are sometimes considered to be a sub-genre of rhythm-action games, described above. As can be seen from FIG. 5, specific dance moves are indicated to the player as directional arrows 502 on the side of the game screen representing various foot positions. This exemplary game allows a player to “dance-along” with the licensed music content on which the video game is based. In some embodiments, the game allows a player to “dance-along” with a musical artist responsible for the licensed music content. In these embodiments, the player may be provided with a character having the appearance of the musical artist responsible for the licensed musical content. Alternatively, the player may be provided with a character having the appearance of the musical artist responsible for the recorded music product from which the music content is selected.

In embodiments in which the gaming platform is provided with a camera, the camera may be used to capture movements of the player. In other embodiments, the player's dance moves may be captured by a floor pad that is connected to the gaming platform.

Other examples of “dance along” video games include Dance Dance Revolution, sold by Konami Digital Entertainment; EyeToy:Groove, sold by Sony Computer Entertainment and Bust A Groove, sold by Square Enix.

### EXAMPLE 5

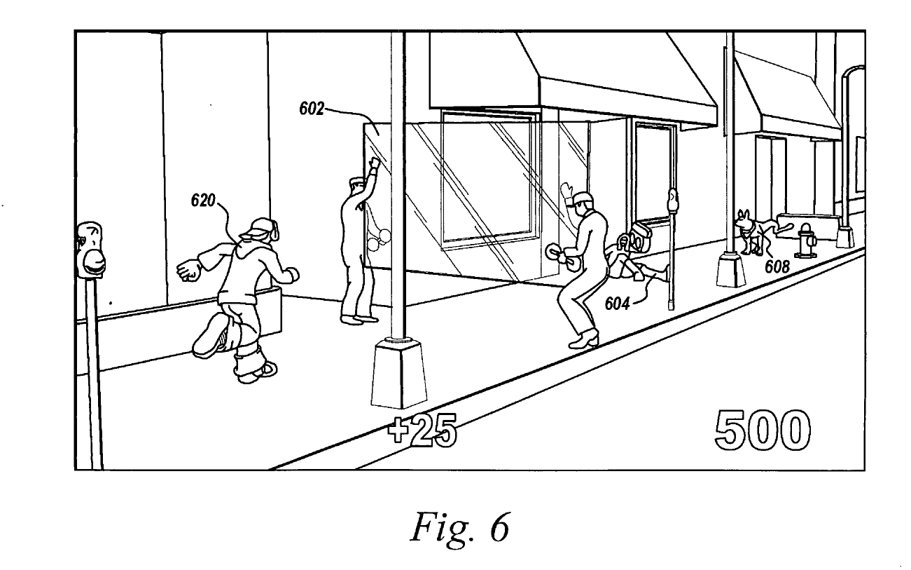

Referring now to FIG. 6, the methods described above may be used to create and sell a music-based character-action game. In the embodiment shown in FIG. 6, musical events are represented as specific obstacles 602, 604, 606 which the player must control a game character 620 to avoid. The obstacles 602, 604, 606 appear in the game character's path, such that the character will collide with the obstacles at the same moment that a musical event associated with the obstacle will be heard in the soundtrack of the video game. The player must control the game character 620 to “dodge” the obstacles 602, 604, 606 by, for example, pressing game controller buttons in synchrony with the musical events in the soundtrack. In some embodiments, the game may offer multiple playing experiences by allowing the player to select a track to play against before starting the game. In other embodiments, the user may use the controller to switch between tracks of the music content during gameplay. In embodiments in which the gaming platform is provided with a camera, the camera may be used to capture movements of the player and the player's body movements may be used to control the game character.

Other examples of music-based third-person character-action games include VibRibbon and MojibRibbon, both by Sony Computer Entertainment.

In specific embodiments character-action games may be used to provide an interactive music video that allows a player to control a digitized character in as that character encounters obstacles, as above. As described above, the player must control the game character to “dodge” the obstacles but, in these specific embodiments, the obstacles and challenges faced by the game player are modeled on, or directly replicate, obstacles and challenges faced by the main character in a traditional music video produced for the licensed music content.

### EXAMPLE 6

In another embodiment, the music-based video game features gameplay like that found in Rez, a “musical shooter” sold by Sega. In these games, the player navigates through a game environment. The player controls a targeting device to choose and shoot targets that exist in the game environment. As the player shoots targets, musical events are triggered that contribute to a soundtrack for the game. The gameplay for these types of games is similar to other “shooter” type games, with the exception that shooting targets directly and explicitly contributes to the musical accompaniment provided by the game.

Referring once again to FIG. A, the created music-based video game is offered for sale in a manner typically associated with the sale of recorded music entertainment products. One aspect of this is the physical location in which the product is made available to consumer. In some embodiments, the created music-based video game is offered for sale by specialty music stores that do not traditionally carry gaming entertainment products. In other embodiments, the created music-based video game is placed in the music department of a larger store, rather than (or in addition to) being placed in the game section of a larger store. In many of these embodiments, the created music-based video game is co-located with the recorded music product on which it is based or, alternatively, with other recorded music products by the same musical artist. For example, the video game may appear in the same bin as recorded music products by the musical artist upon whose music the game is based.

In still other embodiments, the created music-based video game is offered for download from a source traditionally associated with the download of music products, such as the iTunes Store, operated by Apple Computer of Cupertino, Calif. In these embodiments, the music-based video game may be made available for download from the same Web page as the recorded music product on which the video game is based or, alternatively, the video game may be made available for download on a page featuring other recorded music products by the same musical artist. In still other embodiments, the video game may be made available for download on a page featuring recorded music products by different musical artists having some relationship to the recorded music product on which the video game is based. In still other of these embodiments, an electronic search of the site for a particular artists may return both recorded music products as well as video games based on the music content from the recorded music products of that artist.

The video game may be embodied on the same carrier as the music content, for example, they may be offered for sale as a single compact disc or DVD. In other embodiments, the video game and the music content may be offered for sale together but embodied on different carriers. In some embodiments, the music content is embodied in audio format on a compact disc while the video game is embodied on CD or DVD or read-only solid-state memory element. In still further embodiments, the created video game is offered for sale as a separate unit from the recorded music product on which the video game is based. In some of these embodiments, the music content on which the video game is based may not be made separately available to consumers, that is, the only way for a consumer to purchase the music content is to buy the video game based on the music content.

Another aspect of offering the music-based video game for sale in a manner typically associated with the sale of recorded music entertainment products is indicia associated with the packaging of the product when offered for sale. One example of indicia typically associated with recorded music products that is not associated with video games is a “Parental Advisory: Explicit Content” sticker, sometimes referred to as a “PMRC sticker.” Video games typically carry an Entertainment Safety Review Board (ESRB) rating, such as Mature (M), Teen (T), or Everyone (E). The created music-based video game may include a PMRC sticker rather than, or in addition to, an ESRB rating.

In yet another aspect, the video game may be offered for sale at a price the signals to a consumer that it is a music product. For example, video games are typically more expensive than music products. The music-based video game of the current invention may be offered for a price lower than that typically charged for a video game, closer to that of recorded music products.

In still another aspect, the messaging and positioning associated with the video game may signal to a consumer that the video game is more like a recorded music product than a typical video game. For example, the video game may be marketed as “a video game version of the new album” from a particular artist. In other embodiments, the video game may be advertised in industry periodicals normally associated with the music industry, such as Rolling Stone or Spin magazine, rather than (or in addition to) those associated with the video game industry, such as Electronic Gaming Monthly.

While the invention has been shown and described with reference to specific preferred embodiments, it should be understood by those skilled in the art that various changes in form and detail may be made therein without departing from the spirit and scope of the invention as defined by the following claims.

1. A method for selling a music-based video game, the method comprising the steps of:
(a) selecting a quantum of music content;
(b) creating a video game based on the selected music content; and
(c) offering for sale the created video game in a manner typically associated with recorded music products.

2. The method of claim 1 wherein step (b) comprises creating a rhythm action video game based on the selected music content.

3. The method of claim 1 wherein step (b) comprises creating a singing video game based on the selected music content.

4. The method of claim 1 wherein step (b) comprises creating a dancing video game based on the selected music content.

5. The method of claim 1 wherein step (b) comprises creating a shooting game based on the selected music content.

6. The method of claim 1 wherein step (b) comprises creating a character action game based on the selected music content.

7. The method of claim 1 wherein step (b) comprises creating a video game based on the selected music content in which user input is received via a camera.

8. The method of claim 1 wherein step (b) comprises creating a video game based on the selected music content in which user input is received via a floor pad.

9. The method of claim 1 wherein step (b) comprises creating a video game based on the selected music content in which user input is received via a microphone.

10. The method of claim 1 wherein step (b) comprises creating a video game based on the selected music content in which user input is received via a game controller.

11. The method of claim 1 wherein step (b) comprises creating a video game based on the selected music content in which a musical time axis is represented as a spatial path.

12. The method of claim 11 wherein the spatial path does not lie within an image plane of a display and is rendered, into the image plane of the display.

13. The method of claim 1 wherein step (b) comprises creating a video game based on the selected music content in which a musical time axis is represented as a spatial path that leads to a computer-generated likeness of a musician.

14. The method of claim 13 wherein the musician is at least partially responsible for the selected music content.

15. The method of claim 13 wherein the spatial path does not lie within an image plane of a display and is rendered into the image plane of the display.

16. The method of claim 1 wherein step (b) comprises creating a video game based on the selected music content in which a musical time axis is represented as a spatial path that does not lie within an image plane of a display and in which the spatial path leads to a computer generated likeness of a musician.

17. The method of claim 1 wherein step (b) comprises creating a video game based on the selected music content and including a digitized likeness of a musician at least partially responsible for creating the selected music content.

18. The method of claim 17 wherein the digitized likeness of the musician is an animated, computer-generated model of the musician.

19. The method of claim 1 wherein step (c) comprises offering for sale as a single unit a first article of manufacture including the selected music content in a music playback format and a second article of manufacture including the created video game, the single unit offered for sale in a manner typically associated with a recorded music product.

20. The method of claim 1 wherein step (c) comprises offering for sale as a single unit a single article of manufacture including the selected music content and the created video game in a manner Typically associated with a recorded music product.

21. The method of claim 1 wherein step (c) further comprises offering for sale separately the selected music content and the created video game in proximity to one another within a retail store in a manner typically associated with a recorded music product.

22. The method of claim 1 wherein step (c) further comprises making available for download from a single location the selected music content and the created video game.

23. The method of claim 1 wherein step (c) further comprises making the selected music content available for sale exclusively through the created video game.

24. A method for creating an interactive music video for a musical composition performed by a real world musical artist, the method comprising the steps of:
(a) creating a computer-generated rendition of the musical artist; and
(b) creating a video game based on the musical composition that receives input from a player and includes the created computer-generated rendition of the musical artist as a game element with which the player interacts.

25. The method of claim 24 wherein step (b) comprises creating a video game based on the musical composition in which a musical time axis is represented as a spatial path

26. The method of claim 25 wherein the spatial path does not lie in an image plane of the display and which leads to the computer-generated rendition of the musical artist.

27. The method of claim 1 wherein step (c) comprises offering for sale the created video game through a distribution channel typically associated with recorded music products.

28. The method of claim 1 wherein step (c) comprises offering for sale the created video game using product placement typically associated with recorded music products.

29. The method of claim 1 wherein step (c) comprises offering for sale the created video game bearing indicia on packaging typically associated with recorded music products.

30. The method of claim 1 wherein step (c) comprises offering for sale the created video game at a price typically associated with recorded music products.

31. The method of claim 1 wherein step (c) comprises advertising the created video game in media typically associated with recorded music products.

32. The method of claim 1 wherein step (c) comprises positioning the created video game, through language used on one of packaging and advertising, in a manner typically associated with recorded music products.
